(19) United States
(12) Patent Application Publication
(10) Pub. No.: US 2021/0223138 A1
(43) Pub. Date: Jul. 22, 2021

(54) MEASUREMENT METHOD AND MEASUREMENT APPARATUS

(71) Applicants: CHONGQING HKC OPTOELECTRONICS TECHNOLOGY CO., LTD., Chongqing (CN); HKC CORPORATION LIMITED, Shenzhen (CN)

(72) Inventor: WEI CHEN, Chongqing (CN)

(21) Appl. No.: 16/311,697

(22) PCT Filed: Oct. 23, 2018
(86) PCT No.: PCT/CN2018/111328

§ 371 Date: Dec. 20, 2018

(30) Foreign Application Priority Data
Sep. 11, 2018 (CN) 201811055950.9

(51) Int. Cl. G01M 11/02; G01M 11/00

(52) U.S. Cl. CPC G01M 11/0207; G01M 11/3145

(57) ABSTRACT

This application discloses a measurement method and a measurement apparatus. The measurement method includes steps of: measuring a to-be-measured object at least twice and recording measurement values; removing extreme values from the measurement values; and obtaining final measurement data based on the remaining measurement values.

### MEASUREMENT METHOD AND MEASUREMENT APPARATUS

This application claims priority to Chinese Patent Application No. CN201811055950.9, filed with the Chinese Patent Office on Sep. 11, 2018 and entitled “MEASUREMENT METHOD AND MEASUREMENT APPARATUS”, which is incorporated herein by reference in its entirety.

### TECHNICAL FIELD

This application relates to the field of display technologies, and more specifically, to a measurement method and a measurement apparatus.

### BACKGROUND

Statement herein merely provides background information related to this application and does not necessarily constitute the prior art.

Displays controlled by using an active switch include a liquid crystal display, an OLED display, and the like. The liquid crystal display has many advantages such as a thin body, a power saving feature, and no radiation and is widely applied. Most of liquid crystal displays known to the inventor are backlight-type liquid crystal displays, including liquid crystal panels and backlight modules. A working principle of a liquid crystal panel is placing liquid crystal molecules between two parallel glass substrates and applying a drive voltage to the two glass substrates to control a rotation direction of the liquid crystal molecules, to refract light of the backlight module to generate a picture. An organic light-emitting diode (OLED) display is also referred to as an organic electro luminescence display and has many advantages such as self-illumination, a short response time, high definition, a large contrast ratio, and a capability of implementing flexible display and large-area full-color display. Great performance and much market potential of the OLED display have attracted a great quantity of manufacturers and scientific research mechanisms all over the world to devote themselves to production and research and development of OLED display panels.

The liquid crystal display and the OLED display both use an optical measurement device in a production process. The optical measurement device is easily subject to external light, device vibration, and environment factors during measurement, and consequently, a measurement result has a relatively large error.

### SUMMARY

In view of the foregoing defect, a technical problem to be resolved in this application is to provide a measurement method and a measurement apparatus for reducing a measurement error.

To achieve the foregoing objective, this application provides a measurement method. The method comprises steps of:

measuring a to-be-measured object at least twice and recording measurement values;

removing extreme values from the measurement values; and

obtaining final measurement data based on the remaining measurement values.

Optionally, the extreme values comprise a largest value and a smallest value.

Optionally, the step of obtaining final measurement data based on the remaining measurement values comprises:

calculating a mean of the remaining measurement values and obtaining the final measurement data.

Optionally, the step of removing extreme values from the measurement values comprises:

recording the measurement values on a coordinate axis;

setting a discrete area and a non-discrete area according to distribution distances of the measurement values on the coordinate axis, wherein a difference between close measurement values in the non-discrete area is less than that in the discrete area, and there are at least two non-discrete areas;

setting measurement values in the discrete area as the extreme values; and

dividing weights of measurement values in the at least two non-discrete areas according to a difference between two close measurement values; and

the step of calculating a mean of the remaining measurement values and obtaining the final measurement data comprises: performing weighted averaging according to weights of the measurement values and obtaining the final measurement data.

Optionally, the step of measuring a to-be-measured object at least twice and recording measurement values comprises: measuring the to-be-measured object for three times;

the step of removing extreme values from the measurement values comprises: removing the largest value and the smallest value from the measurement values; and

the step of obtaining final measurement data based on the remaining measurement values comprises:

using a median as the final measurement data.

Optionally, the number of the measurement values is five to ten.

This application further discloses a measurement method, comprising steps of:

performing optical measurement on a to-be-measured object at least twice and recording measurement values;

removing extreme values from the measurement values; and

calculating a mean of the remaining measurement values and obtaining final measurement data, wherein

the extreme values comprise a largest value and a smallest value.

This application further discloses a measurement apparatus, wherein the measurement apparatus comprises:

a measurement chip, configured to measure a to-be-measured object at least twice and record measurement values;

a filtering circuit, configured to remove extreme values from the measurement values; and

a calculator, configured to calculate a mean of the remaining measurement values and obtain final measurement data.

Optionally, the extreme values comprise a largest value and a smallest value.

Optionally, the filtering circuit is configured to: set a discrete area and a non-discrete area according to the measurement values and set measurement values in the discrete area as the extreme values; and

a difference between close measurement values in the non-discrete area is less than that in the discrete area.

The inventor finds through research that a measurement device is easily subject to external light, device vibration, and environment factors during measurement, and consequently, a measurement result has a relatively large error. Light intensity measured by an optical device is a result obtained by a photoelectric sensor by converting light intensity into discrete voltages and performing integration within a time period. Therefore, when the photoelectric sensor collects each discrete voltage, photoelectric conversion caused because the photoelectric sensor is subject to change of ambient light intensity or device vibration leads to an excessively large error of a final measurement result. In this application, a to-be-measured point is continuously measured for a plurality of times. After the extreme values are removed, the remaining measurement values are all relatively close to real values. Therefore, the final measurement data is obtained from the remaining measurement values. In this way, a measurement error caused in a measurement process because the optical device is subject to factors such as ambient light and device vibration can be eliminated or weakened, thereby improving measurement accuracy. In addition, in this application, hardware improvement does not need to be performed on an existing device, and costs are low.

### BRIEF DESCRIPTION OF DRAWINGS

The included accompanying drawings are used to provide further understanding of the embodiments of this application, constitute a part of the specification, and are used to illustrate implementations of this application and explain the principle of this application together with literal descriptions. Apparently, the accompanying drawings in the following descriptions are merely some embodiments of this application, and a person of ordinary skill in the art can also obtain other accompanying drawings according to these accompanying drawings without involving any creative effort. In the accompanying drawings:

FIG. 1 is a schematic diagram of a measurement method according to an embodiment of this application.

FIG. 2 is a schematic diagram of a measurement method according to another embodiment of this application.

FIG. 3 is a schematic diagram of setting a discrete area and a non-discrete area according to another embodiment of this application.

FIG. 4 is a schematic diagram of a plurality of non-discrete areas according to another embodiment of this application.

FIG. 5 is a schematic data distribution diagram of obtaining a mean by using six measurement values according to another embodiment of this application.

FIG. 6 shows a measurement apparatus according to another embodiment of this application.

1, measurement chip; 2, filtering circuit; 3, calculator.

### DETAILED DESCRIPTION

Specific structures and functional details disclosed herein are merely representative, and are intended to describe the objectives of the exemplary embodiments of this application. However, this application may be specifically implemented in many alternative forms, and should not be construed as being limited to the embodiments set forth herein.

In the description of this application, it should be understood that orientation or position relationships indicated by the terms such as “center”, “transverse”, “on”, “below”, “left”, “right”, “vertical”, “horizontal”, “top”, “bottom”, “inside”, and “outside” are based on orientation or position relationships shown in the accompanying drawings, and are used only for ease and brevity of illustration and description, rather than indicating or implying that the mentioned apparatus or component must have a particular orientation or must be constructed and operated in a particular orientation. Therefore, such terms should not be construed as limiting of this application. In addition, the terms such as “first” and “second” are used only for the purpose of description, and should not be understood as indicating or implying the relative importance or implicitly specifying the number of the indicated technical features. Hence, features defined by “first” or “second” may explicitly indicate or implicitly include one or more of the features. In the description of this application, unless otherwise stated, “a plurality of” means two or more than two. In addition, the terms “include”, “comprise” and any variant thereof are intended to cover non-exclusive inclusion.

In the description of this application, it should be noted that unless otherwise explicitly specified or defined, the terms such as “mount”, “install”, “connect”, and “connection” should be understood in a broad sense. For example, the connection may be a fixed connection, a detachable connection, or an integral connection; or the connection may be a mechanical connection or an electrical connection; or the connection may be a direct connection, an indirect connection through an intermediary, or internal communication between two components. Persons of ordinary skill in the art may understand the specific meanings of the foregoing terms in this application according to specific situations.

The terminology used herein is for the purpose of describing specific embodiments only and is not intended to be limiting of exemplary embodiments. As used herein, the singular forms “a”, “an” and “the” are intended to include the plural forms as well, unless the context clearly indicates otherwise. It should be further understood that the terms “include” and/or “comprise” when used in this specification, specify the presence of stated features, integers, steps, operations, elements, and/or components, but do not preclude the presence or addition of one or more other features, integers, steps, operations, elements, components, and/or combinations thereof.

This application is further described below with reference to the accompanying drawings and optional embodiments.

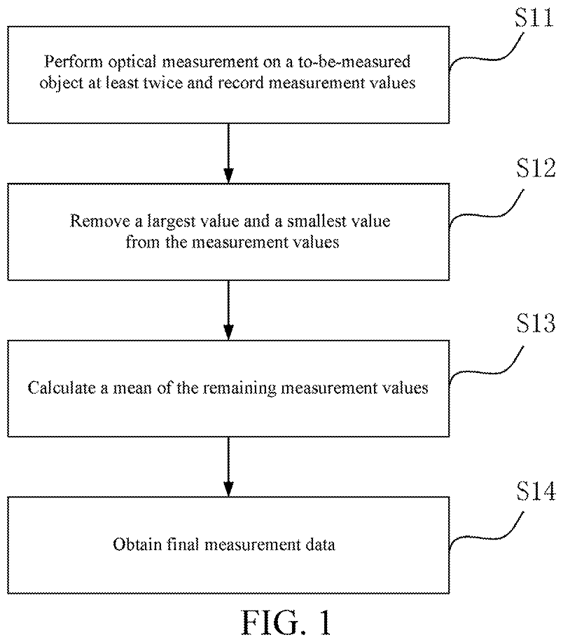

As shown in FIG. 1, an embodiment of this application discloses a measurement method. The method includes steps of:

S11: Perform optical measurement on a to-be-measured object at least twice and record measurement values.

S12: Remove a largest value and a smallest value from the measurement values.

S13: Calculate a mean of the remaining measurement values.

S14: Obtain final measurement data.

Extreme values include the largest value and the smallest value.

The inventor finds through research that an optical measurement device is easily subject to external light, device vibration, and environment factors during measurement, and consequently, a measurement result has a relatively large error. Light intensity measured by an optical device is a result obtained by a photoelectric sensor by converting light intensity into discrete voltages and performing integration within a time period. Therefore, when the photoelectric sensor collects each discrete voltage, photoelectric conversion caused because the photoelectric sensor is subject to change of ambient light intensity or device vibration leads to an excessively large error of a final measurement result. In this application, a to-be-measured point is continuously measured for a plurality of times. After the largest value and the smallest value are removed from the measurement values, the remaining measurement values are all relatively close to real values. Therefore, the final measurement data is obtained from the remaining measurement values. In this way, a measurement error caused in a measurement process because the optical device is subject to factors such as ambient light and device vibration can be eliminated or weakened, thereby improving measurement accuracy. In addition, in this application, hardware improvement does not need to be performed on an existing device, and costs are low. The largest value and the smallest value are farthest from real values. Therefore, after the largest value and the smallest value are removed from the measurement values, a mean obtained from the remaining data is closer to a real value.

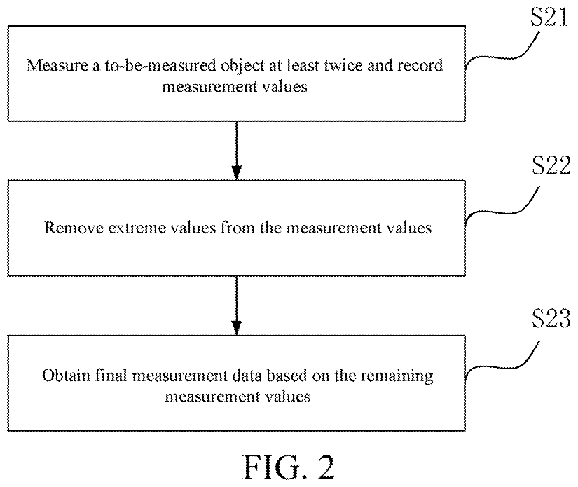

In another embodiment of this application, referring to FIG. 2, a measurement method is disclosed. The method includes steps of:

S21: Measure a to-be-measured object at least twice and record measurement values.

S22: Remove extreme values from the measurement values.

S23: Obtain final measurement data based on the remaining measurement values.

In this implementation, optionally, the extreme values include a largest value and a smallest value.

The largest value and the smallest value are farthest from real values. Therefore, after the largest value and the smallest value are removed from the measurement values, a mean obtained from the remaining data is closer to a real value.

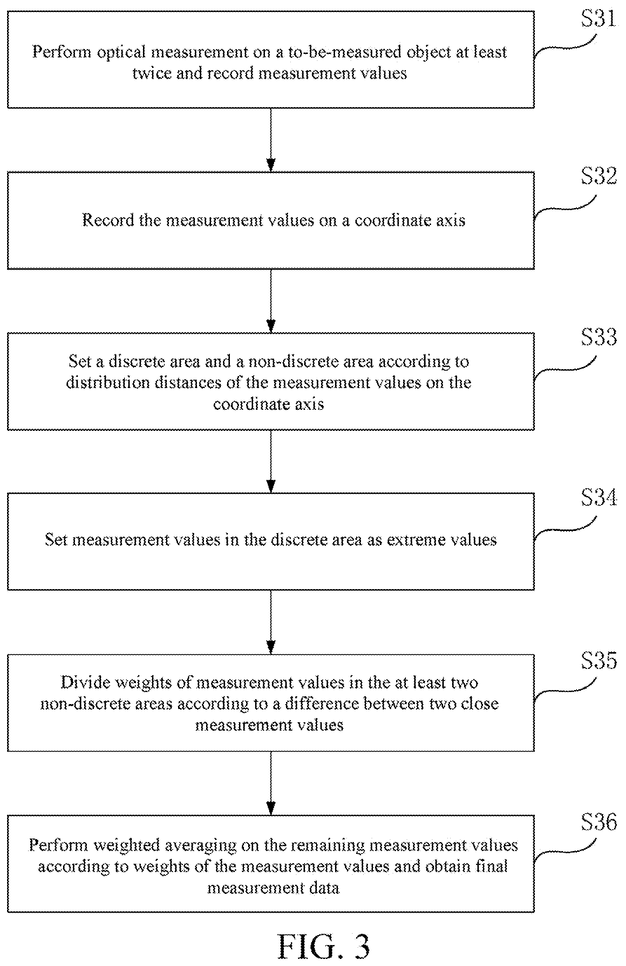

Referring to FIG. 3, in this implementation, optionally, the step of removing extreme values from the measurement values includes:

S31: Measure a to-be-measured object at least twice and record measurement values.

S32: Record the measurement values on a coordinate axis.

S33: Set a discrete area and a non-discrete area according to distribution distances of the measurement values on the coordinate axis, where a difference between close measurement values in the non-discrete area is less than that in the discrete area, and there are at least two non-discrete areas.

S34: Set measurement values in the discrete area as the extreme values.

S35: Divide weights of measurement values in the at least two non-discrete areas according to a difference between two close measurement values.

S36: Perform weighted averaging on the remaining measurement values according to weights of the measurement values and obtain final measurement data.

After the to-be-measured object is measured at least twice, measurement values close to real values get close to each other, and differences are relatively small. Measurement values away from real values get away from each other, and differences are relatively large. Based on the above, the discrete area and the non-discrete area may be divided based on close measurement values, to further improve quality of the remaining measurement values, so that the mean is closer to a real value. The coordinate axis may very intuitively present distances between the measurement values. After the to-be-measured object is measured at least twice, a part of data obviously accumulates, and peripheral data is obviously discretely distributed. Therefore, the discrete area and the non-discrete area may be reasonably divided in a very intuitive manner. For the non-discrete area, measurement values closer to a real value have smaller differences and higher reliability, and should have a higher weight when the mean is obtained. In this way, a measurement error can be further reduced, thereby improving measurement accuracy.

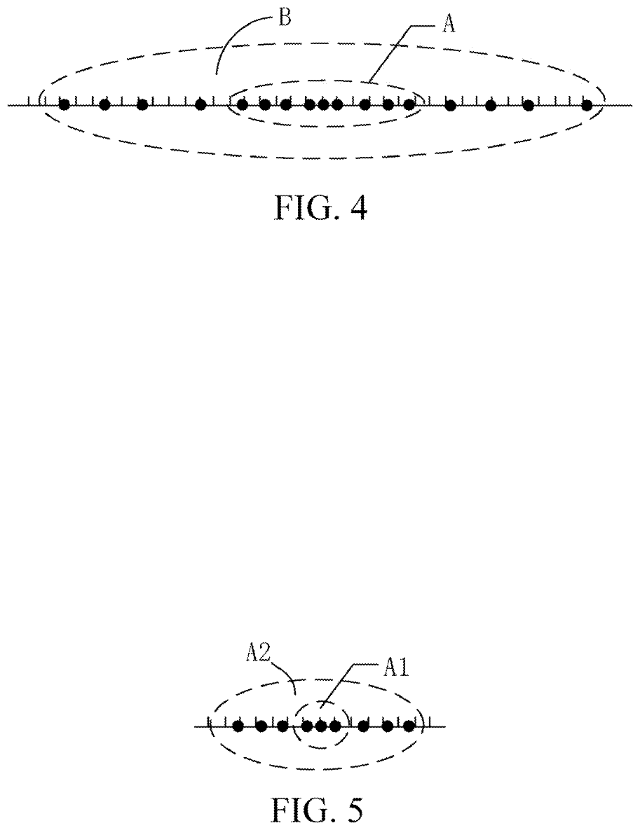

Referring to FIG. 4, each measurement value has a point on the coordinate axis. It may be obviously seen that points in a middle part are relatively dense, and points on two ends present a discrete state. Therefore, an area A may be set as the non-discrete area, and an area B may be set as the discrete area. Measurement values corresponding to the area B are excluded.

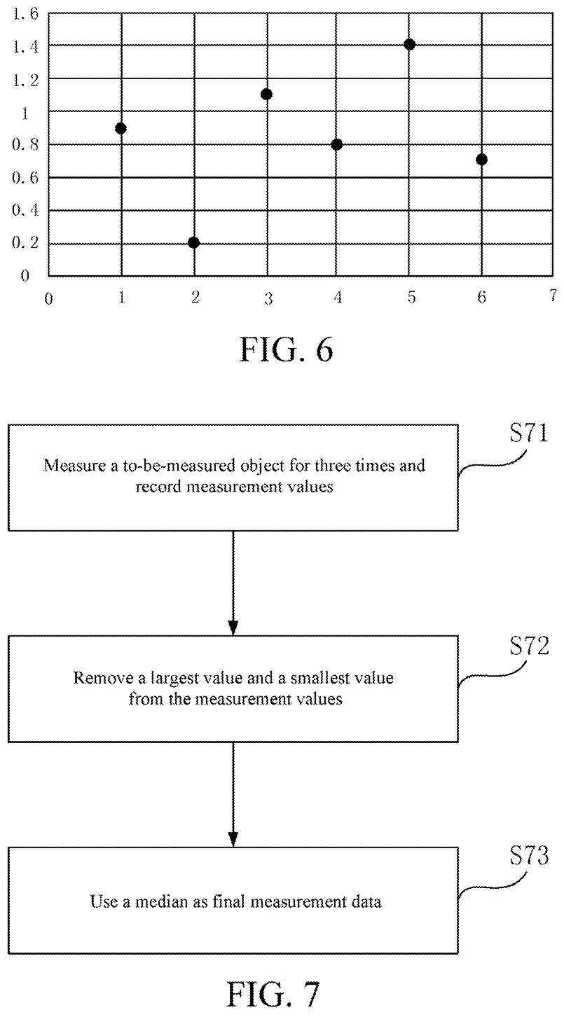

Referring to FIG. 5, in the area A, measurement values closer to a middle area are denser and closer to real values. Therefore, an area A1 and an area A2 may be set. Weights in the part A1 are set to be higher and may be more accurate when the mean is calculated.

For the non-discrete area, measurement values closer to a real value have smaller differences and higher reliability, and should have a higher weight when the mean is obtained. In this way, a measurement error can be further reduced, thereby improving measurement accuracy.

In this implementation, optionally, the number of the measurement values is five to ten. More measurement values cost more time and more power and increase production costs. In an actual production process, a measurement error offset of the measurement device is usually not excessively large. Therefore, measurement accuracy can be guaranteed by controlling the number of measurement values within an interval of five to ten.

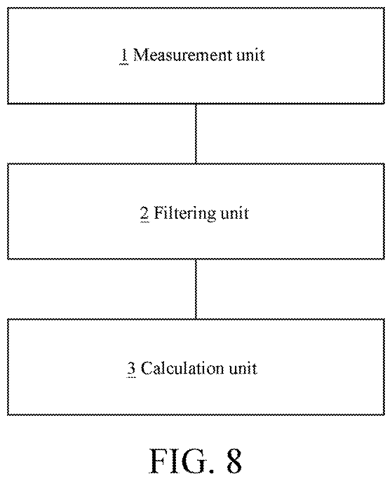

Referring to FIG. 6, a to-be-measured point is continuously measured for six times, a largest value is removed, a smallest value is removed, and then a mean of the remaining four groups of data is used as a final measurement value of the measurement point. In this way, a measurement error caused in a measurement process because the optical device is subject to factors such as ambient light and device vibration can be eliminated or weakened.

In another embodiment of this application, referring to FIG. 7, a measurement method is disclosed. The method includes steps of:

S71: Measure a to-be-measured object for three times and record measurement values.

S72: Remove a largest value and a smallest value from the measurement values.

S73: Use a median as final measurement data.

In this implementation, a measurement error caused in a measurement process because the optical device is subject to factors such as ambient light and device vibration can be eliminated or weakened, thereby improving measurement accuracy. In addition, a larger quantity of times of measurement indicates lower efficiency. Therefore, to ensure, based on the number of times of measurement as small as possible, that values are relatively reliable, obtaining the median through measurement for three times is a relatively simple and effective method. The largest value and the smallest value are removed, and the median is very close to a real value, may be totally applied to general occasions, and satisfies a precision requirement. In addition, in this implementation, hardware improvement does not need to be performed on an existing device, and costs are low.

In another embodiment of this application, referring to FIG. 8, a measurement apparatus is disclosed. The measurement apparatus includes:

a measurement chip 1, configured to measure a to-be-measured object at least twice and record measurement values;

a filtering circuit 2, configured to remove extreme values from the measurement values; and

a calculator 3, configured to calculate a mean of the remaining measurement values and obtain final measurement data.

In this implementation, optionally, the extreme values include a largest value and a smallest value.

The largest value and the smallest value are farthest from real values. Therefore, after the largest value and the smallest value are removed from the measurement values, a mean obtained from the remaining data is closer to a real value.

In this implementation, optionally, the filtering circuit is configured to: set a discrete area and a non-discrete area according to the measurement values and set measurement values in the discrete area as the extreme values; and

a difference between close measurement values in the non-discrete area is less than that in the discrete area.

The panel in this application may be a twisted nematic (TN) panel, an in-plane switching (IPS) panel, or a multi-domain vertical alignment (VA) panel, and may certainly be any other suitable type of panel.

The foregoing contents are detailed descriptions of this application in conjunction with specific optional embodiments, and it should not be considered that the specific implementation of this application is limited to these descriptions. Persons of ordinary skill in the art can further make simple deductions or replacements without departing from the concept of this application, and such deductions or replacements should all be considered as falling within the protection scope of this application.

What is claimed is:

1. A measurement method, comprising steps of:
measuring a to-be-measured object at least twice and recording measurement values;
removing extreme values from the measurement values; and
obtaining final measurement data based on the remaining measurement values.

2. The measurement method according to claim 1, wherein the extreme values comprise a largest value and a smallest value.

3. The measurement method according to claim 2, wherein the step of obtaining final measurement data based on the remaining measurement values comprises:
calculating a mean of the remaining measurement values and obtaining the final measurement data.

4. The measurement method according to claim 3, wherein the step of removing extreme values from the measurement values comprises:
recording the measurement values on a coordinate axis;
setting a discrete area and a non-discrete area according to distribution distances of the measurement values on the coordinate axis, wherein a difference between adjacent measurement values in the non-discrete area is less than a difference between adjacent measurement values in the discrete area, and there are at least two non-discrete areas;
setting measurement values in the discrete area as the extreme values; and
dividing weights of measurement values in the at least two non-discrete areas according to a difference between two adjacent measurement values; and
the step of calculating a mean of the remaining measurement values and obtaining the final measurement data comprises: performing weighted averaging according to weights of the measurement values and obtaining the final measurement data.

5. The measurement method according to claim 2, wherein the step of obtaining final measurement data based on the remaining measurement values comprises:
obtaining a median of the remaining measurement values and obtaining the final measurement data.

6. The measurement method according to claim 1, wherein the number of the measurement values is five to ten.

7. The measurement method according to claim 1, wherein the to-be-measured object comprises a display panel.

8. A measurement method, comprising steps of:
performing optical measurement on a to-be-measured object at least twice and recording measurement values;
removing extreme values from the measurement values; and
calculating a mean of the remaining measurement values and obtaining final measurement data, wherein the extreme values comprise a largest value and a smallest value.

9. A measurement apparatus, wherein the measurement apparatus comprises:
a measurement chip, configured to measure a to-be-measured object at least twice and record measurement values;
a filtering circuit, configured to remove extreme values from the measurement values; and
a calculator, configured to obtain final measurement data based on the remaining measurement values.

10. The measurement apparatus according to claim 9, wherein the extreme values comprise a largest value and a smallest value.

11. The measurement apparatus according to claim 9, wherein the filtering circuit is configured to: set a discrete area and a non-discrete area according to the measurement values and set measurement values in the discrete area as the extreme values; and
a difference between close measurement values in the non-discrete area is less than that in the discrete area.

12. The measurement apparatus according to claim 10, wherein the calculator is configured to:
calculate a mean of the remaining measurement values and obtain the final measurement data.

13. The measurement apparatus according to claim 12, wherein the filtering circuit is configured to:
record the measurement values on a coordinate axis;
set a discrete area and a non-discrete area according to distribution distances of the measurement values on the coordinate axis, wherein a difference between adjacent measurement values in the non-discrete area is less than a difference between adjacent measurement values in the discrete area, and there are at least two non-discrete areas;
set measurement values in the discrete area as the extreme values; and
divide weights of measurement values in the at least two non-discrete areas according to a difference between two adjacent measurement values; and
the step of calculating a mean of the remaining measurement values and obtaining the final measurement data comprises: performing weighted averaging according to weights of the measurement values and obtaining the final measurement data.

14. The measurement apparatus according to claim 10, wherein the calculator is configured to:
obtain a median of the remaining measurement values and obtain the final measurement data.

15. The measurement apparatus according to claim 9, wherein the number of the measurement values is five to ten.

16. The measurement apparatus according to claim 15, wherein the number of the measurement values is six.

17. The measurement apparatus according to claim 9, wherein the to-be-measured object comprises a display panel.
